(19) United States
(12) Patent Application Publication
(10) Pub. No.: US 2011/0180211 A1
(43) Pub. Date: Jul. 28, 2011

(54) Method for Joining Two Components

(75) Inventors: Reinhold Jurischka, Muenchen (DE); Joseph Lass, Muenchen (DE)

(73) Assignee: PARltec GmbH, Stamberg (DE)

(21) Appl. No.: 12/737,105

(22) PCT Filed: May 28, 2009
(86) PCT No.: PCT/EP2009/056525

§ 371 Date: Apr. 6, 2011

(30) Foreign Application Priority Data
Jun. 6, 2008 (DE) 10 2008 027 026.1

(51) Int. Cl. B32B 37/06; B32B 37/02

(52) U.S. Cl. 156/322

(57) ABSTRACT

The invention relates to a method for joining a first component (10) to a second component (12), wherein the second component contains a thermoplastic material. The method comprises the following steps: bringing the first component in contact with the second component; heating the thermoplastic material of the second component at least in the vicinity of the first component to a temperature above the softening temperature of the thermoplastic material but below the decomposition temperature of the thermoplastic material; displacing the heated thermoplastic material such that an at least positive connection is created between the first component and the second component; and cooling the thermoplastic material to a temperature below the softening temperature thereof.

The invention relates to a method for joining a first component to a second component, wherein the second component contains a thermoplastic material.

The methods for joining components known from the prior art are largely based on adhesive or clamped connections. In particular for joining flat components made of silicon, metal, glass or ceramics, for example, with a plastic body, these are predominantly glued into or onto the plastic body. Several types of plastic cannot, however, be glued or can be glued only after an elaborate pre-treatment. Additionally, each element that is used for medical applications, such as adhesives, needs special permissions and has to be biocompatible. Evaporation of the adhesive may additionally lead to an alteration or even destruction of the components. A further disadvantage of the adhesive method is the possibly long curing time of the adhesive as well as its exact positioning and dosage. For example, a non-uniform distribution of the adhesive may lead to a non-uniform and possibly untight connection of the components.

Clamped connections need additional design features such as undercuts, which serve for clamping. This requires an additional effort in the production and increased space requirements. Moreover, in most cases the clamping imposes a continuous mechanical load upon the components to be joint, which load might damage or destroy them.

It is an object of the invention to provide a time-saving and cost-effective method for joining two components, which does not require additives or additional structures.

This object is achieved by means of a method having the features of claim 1. Preferred embodiments are defined in the remaining claims.

The method of the invention is a method for joining a first component to a second component, wherein the second component contains a thermoplastic material. The method comprises the following steps: brining the first component into contact with the second component; heating the thermoplastic material of the second component at least in the vicinity of the first component to a temperature above the softening temperature of the thermoplastic material but below the decomposition temperature of the thermoplastic material; displacing the heated thermoplastic material so as to create an at least positive connection between the first component and the second component; and cooling the thermoplastic material to a temperature below the softening temperature thereof. The first component is preferably chosen to be flat such that a width of the first component is larger than a height (thickness) of the first component. A thermoplastic material (thermoplastic resin) is a plastic that can be deformed at a temperature above its softening temperature (or glass transition temperature). At temperatures above the decomposition temperature, thermal decomposition of the material takes place. In the method of the invention the thermoplastic material of the second component is preferably heated to a temperature lying 15 to 150° above its softening temperature.

The material of the first component and the thermoplastic material may be chosen such that the thermoplastic material has a larger expansion coefficient (thermal expansion coefficient) than the material of the first component. In this case, the thermoplastic material shrinks more upon cooling than the first component, thus imposing a clamping force onto the first component after cooling, which contributes, in addition to the positive fit, to a strong connection of the first with the second component. Apart from the expansion coefficient of the thermoplastic material and of the material of the first component, also the modulus of elasticity (Young's modulus) of the thermoplastic material exerts influence upon the magnitude of this clamping force and, thus, upon the strength and tightness of the connection. The smaller the Young's modulus, that is the more elastic the thermoplastic material, the smaller the clamping force acting upon the first component. Consequently, the thermoplastic material and the material of the first component may be chosen according to the intended purpose of the joint of the first and the second component so as to exert a desired amount of the clamping force onto the first component. If a high degree of strength and tightness of the joint is necessary, for example at high external pressures, the materials may be chosen so as to obtain a correspondingly large acting clamping force. On the other hand, for example, if the first components are pressure-sensitive, such materials may be used so as to obtain a correspondingly small acting clamping force in order to prevent impairment or damage to the first component.

As described above, the first component and the second component form a positive connection by displacing the heated and thus deformable thermoplastic material. Due to the displacement, the heated thermoplastic material is pressed against at least a part of the first component and, thus, abuts at least a part of the surface of the first component. If these surfaces of the first component in contact with the thermoplastic material have a certain degree of surface roughness, an interlocking of the thermoplastic material with the rough surfaces of the first component takes place, which further increases the strength and the tightness of the joint. This surface roughness may be created for example during the production process (for example when sawing or laser-cutting) of the first component so that no further processing step is necessary, or it may be brought about or increased in an additional roughening step. In this manner, the strength and tightness of the joints may be influenced also beyond the degree of surface roughness of the corresponding surfaces of the first component, wherein a larger surface roughness allows for a stronger and tighter joint. Therefore, the method according to the invention provides a secure and pressure-tight connection and offers, in particular by the combination of positive fit with the above-described clamping force, a joint having a high strength and tightness even at high external pressure.

Since no additional structures are necessary for joining the first component to the second component and, thus, no additional space requirements exist, the method according to the invention is very well suited to be in particular used in the fields of microtechnology, such as, for example: microelectronics, for example for RFID-chips or microcontrollers incorporated in plastic; sensor technology, for example for sensor elements in plastic packaging, clothing or accessories (for example bags, suitcases); micromechanics, for example for fixing acceleration sensor elements or pressure sensors in plastic; microoptics, for example for embedding optical lenses or luminous elements (for example LEDs) in plastic; and in particular microfluidics, for example for integrating valves (micro valves), micro pumps, pressure sensors, mixing elements and sensors into lab-on-a-chip systems.

Further, the method may be used without problems for medical applications, and it allows short process times because no additives such as adhesives are used. Therefore, also further problems possibly occurring when using additives, for example evaporation impairing the components, the necessary exact positioning and dosage of the additives as well as their longer curing times, are obviated by the method according to the invention.

Preferably, the second component has a recess, and the first component is at least partially inserted into this recess in order to bring it into contact with the second component. This approach allows for a particularly exact positioning of the first and second component in relation to each other and reliably prevents a displacement of the first component with respect to the second component during the process of joining. Thus, a high position precision of the joint is ensured, which is advantageous in particular in applications in microtechnology. The recess may be created directly during the production of the second component, for example by using a corresponding mould in an injection moulding process, or subsequently after finishing the second component, for example by a corresponding cutting or punching process.

In an embodiment of the invention, the first component consists of a heat conducting material, and the heating of the thermoplastic material is effected through the first component. Here, it is advantageous if the thermal conductivity of the first component is larger than the thermal conductivity of the thermoplastic material of the second component, and the first component has an aspect ratio (height (thickness)/width) of less than 0.5. The method of this embodiment ensures that the thermoplastic material is selectively heated in the proximity of the first component so as to allow an accurately positioned joint. Since heating the thermoplastic material is effected through the first component, thus having to heat only the first component during the joining process of the two components, it is moreover possible to employ a simplified production structure for the joining methods.

Further, in this embodiment the thermoplastic material preferably possesses a higher expansion coefficient (thermal expansion coefficient) than the material of the first component. In this case, the thermoplastic material contracts more upon cooling than the first component, thus imposes a clamping force upon the first component after cooling, which contributes, in addition to the positive fit, to a strong joint of the first with the second component.

In a further embodiment of the invention, heating of the thermoplastic material is effected through the second component, wherein the thermoplastic material is preferably directly heated, for example by bringing it into contact with a heated element. Since in this embodiment the first component does not have to be heated during the joining process, this embodiment is particularly advantageous when using a heat-sensitive first component and when using first components having a low thermal conductivity.

Preferably, both the heating of the thermoplastic material and the displacing of the heated thermoplastic material is effected by means of a die, preferably by means of a hot stamping die. Since only one element (that is the die) is thus needed for heating and displacing the thermoplastic material, the production structures used for the method of the invention, for example a hot stamping structure, may be kept simple. The die preferably consists of a heat conductive and hard material, at least as compared to the hardness of the thermoplastic material, wherein in particular materials having a high thermal conductivity such as metals (for example nickel, iron, copper, aluminium and so on) or silicon are advantageous. The heating of the thermoplastic material is effected through heat conduction by bringing into direct contact the die heated to a temperature above the softening temperature of the thermoplastic material and either the first or the second component, or both components. The part of the die coming into contact with the component(s) may be flat (2-dimensional) or formed with a corresponding patterning (structuring), according to the configuration of the first component and which of the components effects the heating. The displacement of the heated thermoplastic material is effected by means of pressure exerted by the die upon the first component, the second component or both components, wherein the die is in direct contact with the corresponding component(s) also during the displacement process.

In an embodiment of the invention the die contacts the first component during heating of the thermoplastic material and the displacement of the heated thermoplastic material. Preferably, the die only contacts the first component consisting of a thermally conductive material. In this case, the first component is heated by the die and releases heat to the thermoplastic material of the second component at least in the vicinity of the first component, thereby heating the thermoplastic material to a temperature above its softening temperature. The heated thermoplastic material is displaced by pressure exerted by the die through the first component onto the material so as to create at least a positive connection between the first component and the second component.

In a further embodiment of the invention, the die contacts the second component during the heating of a thermoplastic material and the displacement of the heated thermoplastic material. The die preferably contacts only the second component, preferably only the thermoplastic material of the second component. In this case, the heating of the thermoplastic material is effected directly by thermal conduction between the heated die and the thermoplastic material. For the displacement of the heated thermoplastic material, pressure from the die is directly exerted onto the thermoplastic material.

Further, the method of the invention may also be performed in a way in which the die comes into contact both with the first and with the second component during the heating of the thermoplastic material and the displacement of the heated thermoplastic material.

According to the invention, the second component may consist uniformly of a single thermoplastic material or also of at least two different materials.

In the latter case an embodiment of the invention provides that the at least two materials are thermoplastic materials having different softening temperatures. Preferably in the joining method of this embodiment, only the material having the lower softening temperature is heated to a temperature above its softening temperature. The second component may be configured in a way in which the first component overlies the thermoplastic material having the higher softening temperature when coming into contact with the second component. As the thermoplastic material having the higher softening temperature is not heated above its softening temperature during the joining process and, thus, also is not softened or becomes deformable, it is not displaced during the step of displacing but keeps its original shape. The position of the first component in a direction perpendicular to the contact surface between the first component and the thermoplastic material having the higher softening temperature is thus fixed, allowing for a joint between the first and second component having a high positioning accuracy. Moreover, production parameters such as compression force and compression path, if the joining method is performed in a hot stamping set-up, are structurally limited, and thus a simplified control of the joining process is achieved. Therefore, this embodiment is particularly well-suited for joining microtechnological, preferably microfluidic components such as valves. The at least positive connection between the first and the second component is effected in this embodiment by displacing the heated thermoplastic material having the lower softening temperature.

In a further embodiment of the invention, only one of the at least two materials of the second component is a thermoplastic material. As non-thermoplastic materials metals (e.g. nickel, iron, copper, aluminium etc.), ceramics, non-thermoplastic resins etc. may be used. Similarly to the above-described embodiment, the second component may be configured in a way in which the first component overlies the non-thermoplastic material when contacting the second component. As the non-thermoplastic material is not softened or rendered deformable during the joining process, the advantages described already in detail above arise also in the present embodiment.

According to the method of the invention, the second component may include an electrically conductive material such as a conventional circuit board, which undergoes an electric connection with the first component, for example by means of flip-chip-bonding, when the first component is joined to the second component. This connection allows to electrically connect the first component to external electric or electronic devices (such as current or voltage supply sources, current or voltage meters etc.) and is thus, particularly advantageous for applications in microtechnology, for example when using microchips, microcontrollers, microsensors, LEDs, micropumps or -valves etc. as a first component.

Preferably, the first component consists of silicon or metal or glass or ceramics. The material may be chosen according to the field and purpose of application of the first component. As already explained above, the thermoplastic material of the second component may then be chosen in function of the material of the first component so as to obtain a desired degree of clamping force acting upon the first component after finishing the joint. For example, polycarbonate (PC), polymethyl methacrylate (PMMA), polyvinyl chloride (PVC), polyoxymethylene (POM), cyclo-oleofine copolymers (COC), polyphenylene sulphide (PPS), polyether sulphone (PES), polyether imide (PEI) and polyether ketone (PEK) may be used as thermoplastic materials. According to thermal conductivity and stability of the material of the first component, the heating of the thermoplastic material and the displacement of the heated thermoplastic material may be effected through the first component, the second component or both components.

Preferably, the first component is a microfluidic component, preferably a valve (microvalve). However, the method according to the invention is not limited to such applications, but may in principle be employed in all fields of technology, in particular in microtechnology, in which a stable joint between two components is required.

In the following, the invention is described purely by way of example and by referring to the enclosed drawings, in which

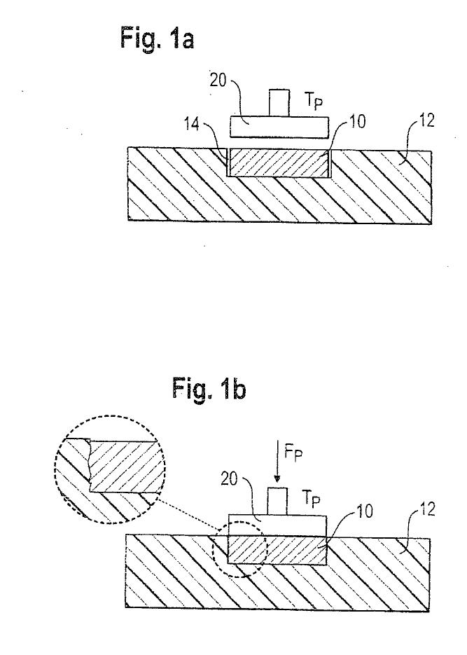

FIGS. 1a and 1b are schematic views illustrating the method of the invention according to a first embodiment;

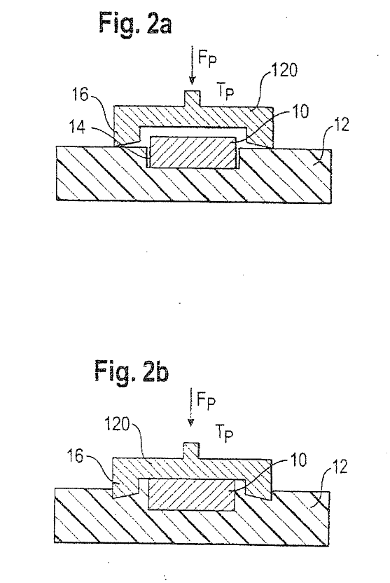

FIGS. 2a and 2b are schematic views illustrating the method of the invention according to a second embodiment;

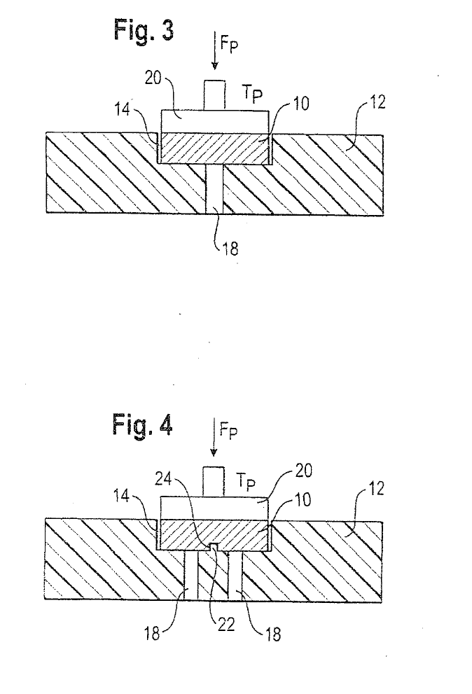

FIG. 3 is a schematic view illustrating a step of the method of the invention according to a third embodiment;

FIG. 4 is a schematic view illustrating a step of the method of the invention according to a fourth embodiment;

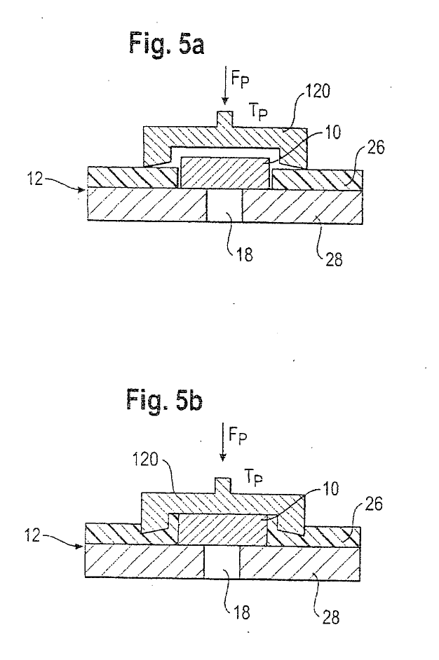

FIGS. 5A and 5B are schematic views illustrating the method of the invention according to a fifth embodiment;

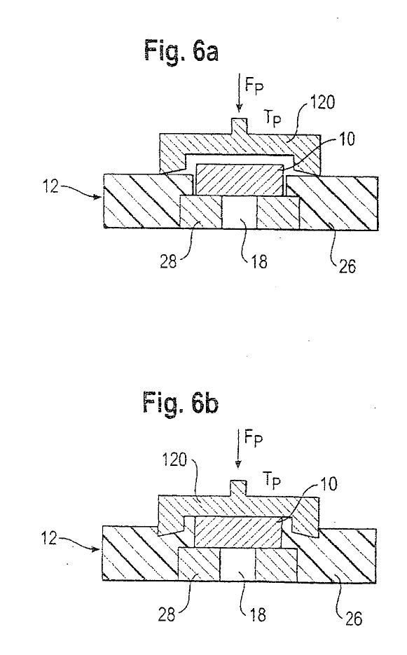

FIGS. 6a and 6b are schematic views illustrating the method of the invention according to a sixth embodiment;

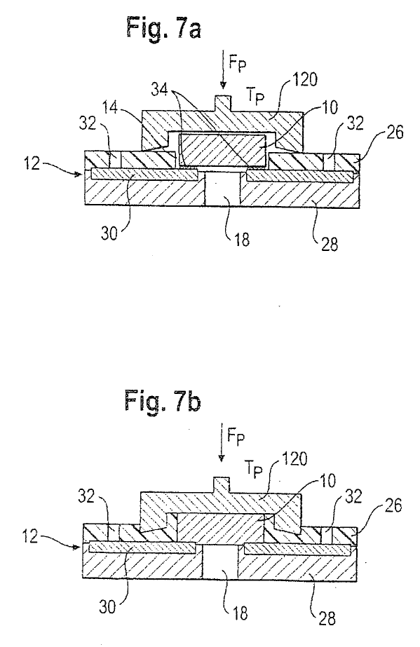

FIGS. 7a and 7b are schematic views illustrating the method of the invention according to a seventh embodiment;

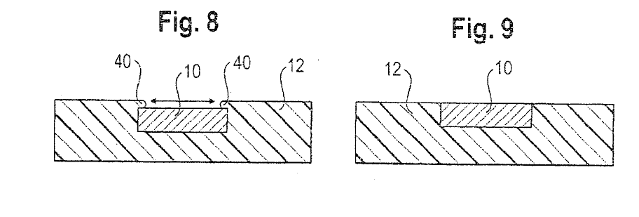

FIG. 8 is a sectional view of a joint of two components produced by the method of the invention according to a first embodiment;

FIG. 9 is a sectional view showing a further joint produced by the method of the invention according to a first embodiment; and

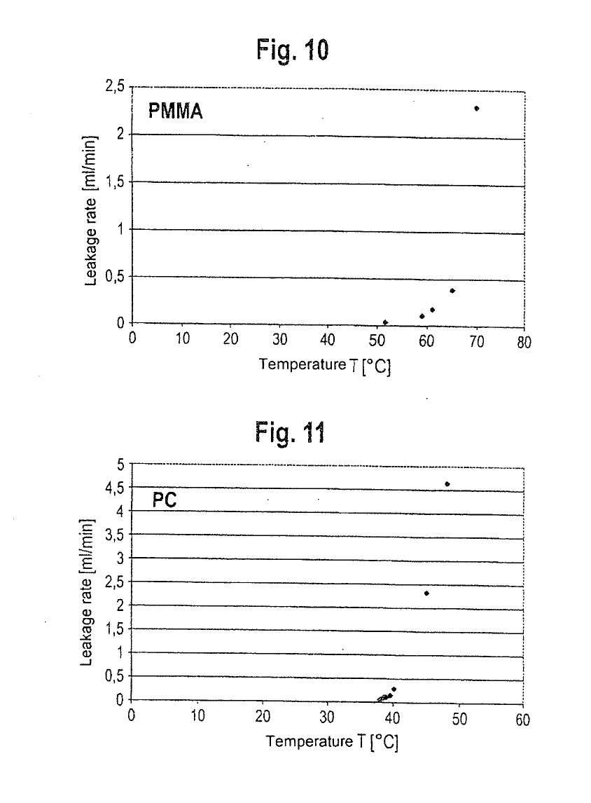

FIGS. 10 to 14 are diagrams of the measured leakage rate as a function of temperature for joints consisting of an un-patterned silicon chip and different thermoplastic materials and produced according to the method of the invention.

FIGS. 1a and 1b are schematic views illustrating the method of the invention according to a first embodiment, wherein the figures show sectional views of first 10 and second components 12 according to the invention and a die 20 according to the invention. The first component 10 is a silicon chip made by sawing or laser-cutting of a silicon wafer and having lateral dimensions of 3×3 mm² and a thickness (in the direction of movement of the die 20, see Fₚ in FIG. 1b) of 1 mm. The silicon chip may in particular be configured as a microelectronic component (having electronic elements such as transistors, diodes etc. arranged thereon) or as a microfluidic component such as a valve, a sensor etc. In the method of this first embodiment, silicon is particularly well-suited for use as first component 10 as it is a stable material having a high specific thermal conduction (157 Wm⁻¹K⁻¹). Silicon chips of this type are used as first component 10 also in the other embodiments described herein. The second component 12 consists uniformly of polycarbonate (PC) of 3 mm thickness and having a softening temperature of 145° C., and comprises a recess 14, the dimensions of which are somewhat larger than those of the first component 10. The die 20 is flat on its side contacting the first component 10 (the lower side in FIGS. 1a and 1b), and consists of copper.

In the first step (not shown) of the method according to this first embodiment, the first component 10 is inserted into the recess 14 of the second component 12. The die 20 is heated, by means of a thermally conductive connection (not shown) to temperature Tₚ of 180° C., which is 35° above the softening temperature of the second component 14. Subsequently, as shown in FIG. 1b, the die 20 is contacted with the first component 10 so as to heat the component 10 to the temperature Tₚ by thermal conduction from the die 20. Thus, the thermoplastic material of the second component 12 in the vicinity of the first component 10 is also heated to the temperature Tₚ, that is above its softening temperature, by thermal conduction from the first component 10. By virtue of a pressure Fₚ of 300 N (typically between 10 and 600 N) exerted by the die 20 onto the first component 10 perpendicular to its surface, the heated thermoplastic material located at the contact surface to the first component 10 is displaced toward the edge of the component. In this step, the second component 12 is fixed in its position by means of a support (not shown). The displaced thermoplastic material is pressed against the side surface of the first component 10 roughened by sawing or laser-cutting, and is interlocked with the surfaces. This operation is schematically shown in FIG. 1b) with the aid of the enlarged illustration marked by a dotted circle, wherein the bent arrow illustrates the flow of the heated thermoplastic material. Thus, the first component 10 is embedded within the second component 12 in positive fit and joined thereto. Afterwards, the die 20 is removed and the thermoplastic is cooled to a temperature below its softening temperature. Since the expansion coefficient of the polycarbonate 12 (7×10⁻⁵K⁻¹) is significantly larger than the one of the silicon chip 10 (2.5×10⁻⁶K⁻¹), the polycarbonate 12 contracts more during cooling than the silicon chip 10, thereby exerting a clamping force onto the chip 10 after cooling. Additionally, as the polycarbonate 12 has a large Young's modulus (2350 Nmm⁻² at room temperature) and thus a low elasticity (thereby allowing to generate substantial clamping forces), this clamping force contributes, in addition to the positive fit, to the strong connection of the chip 10 with the polycarbonate 12.

By changing the magnitude of the applied pressure Fₚ of the die 20, the time during which this pressure acts upon the heated thermoplastic material, and the difference between the height (in the direction of movement of the die 20, see Fₚ in FIG. 1b) of the recess 14 and the thickness of the first component 10, the position of the first component 10 within the second component 12 in a vertical direction (direction of movement of the die 20) may be adjusted after joining has taken place.

As shown in FIG. 9, the first component 10 is for example joined to the second component 12 in a way in which their upper surfaces lie in a common plane so as to achieve an overall flat, smooth surface of the joint. Such a design is particularly advantageous for example if further components are to be attached to the surface of the joint in a subsequent processing step.

On the other hand, as shown in FIG. 8, the first component 10 may be joined to the second component 12 also in such a manner that the upper surface of the first component 10 lies below the upper surface of the second component 12 in a vertical direction. When producing such a joint by the method according to the first embodiment, the displaced thermoplastic material is initially pressed against the side surfaces of the first component 10 due to the pressure exerted by the die 20, as explained above. If the first component 10 is further pressed into the second component 12 so as to move the upper surface of the first component 10 below the one of the second component 12, then the displaced thermoplastic material above the upper surface of the first component 10 is pressed in a direction towards the center of the first component 10. Thereby, after cooling of the joint, an overlap 40 (FIG. 8) is created which is arranged around the entire circumference of the upper mouth of the recess 14. As shown in FIG. 8, this overlap 40 encloses the first component 10 in a vertical direction by positive fit so that a particularly stable joint between the first 10 and the second component 12 is achieved. For example, such a design is particularly advantageous if the joint is exposed to high external pressures during use and, thus, needs to have a particularly high degree of stability.

In the method according to the first embodiment and in the method according to the further embodiments described below, the die 20 is employed in a similar manner as a hot-stamping die in a hot-stamping process, wherein in such a process no joint between two components is achieved, but merely a surface patterning of components. An overview of the method of hot-stamping known in the art can be found in the paper “Heiβprägen von Mikrostrukturen, T. Wagenknecht, K. Rattba and S. Wagner, wt Werkstatttechnik online, vol. 96, H. 11/12, 2006, pages 849-853”.

FIGS. 2a and 2b schematically illustrate a method of the invention according to a second embodiment. The first 10 and the second component 12 are identical to those of the first embodiment, wherein the recess 14 of the second embodiment has a height (in the direction of a movement of the die 20, see Fₚ in FIG. 2a) which is smaller than the thickness of the first component 10. Thus, the first component 10 protrudes above the upper surface of the second component 12 after it has been introduced into the recess 14. In contrast to the first embodiment, the die 120 is not completely flat on its side facing the first 10 and the second component 12, but has a rim 16 enclosing the outer circumference thereof perpendicularly to the direction of motion thereof and having bevelled lower surfaces (on the side facing the second component 12), as shown in FIGS. 2a and 2b. The die 120 is heated to a temperature Tₚ of 180° C. and is subsequently contacted with the second component 12, (FIG. 2b). The thermoplastic material (PC) in the vicinity of the die 120 and of the first component 10 is, thus, heated above its softening temperature and pressed by the bevelled lower surface of the die rim 16 with an applied pressure Fₚ (300 N, typically 10-600 N) against the lateral surfaces of the first component 10 and interlocked therewith (FIG. 2b). In the second embodiment, heating the first component 10 is not necessary so that this embodiment is particularly suited for heat-sensitive components. After joining of the two components 10, 12 has been carried out, the die 120 is removed and the thermoplastic material is cooled to a temperature below its softening temperature. Since the same materials are used for the first 10 and the second component 12 as in the first embodiment, a stable joint of the components 10, 12 arises also in the second embodiment due to a combination of clamping force and positive fit.

The method according to the third embodiment and shown schematically in FIG. 3 is substantially identical to the first embodiment, wherein here the second component 12 is provided with a port (opening) 18 extending from the recess 14 to the lower side of the second component 12 and allowing a communication of the first component 10 fixed to the second component 12 with the environment. This embodiment is particularly advantageous if the first component 10 is a fluidic (microfluidic) component. In this case, the (fluidic) port 18 provides a fluid connection of the first component 10 with the environment.

A joint produced according to this method and having a flat upper surface (see FIG. 9), consisting of an un-patterned silicon chip 10 and a second component 12 made of polycarbonate, was subjected to a tightness test by applying positive pressure via the port 18 to the lower side of the silicon chip 10. The details of the structure for performing this tightness test are described in the following. Here, pressure-tightness of the connection of the two components 10, 12 was measured at applied pressures above 6 bar.

The method according to the fourth embodiment schematically shown in FIG. 4 is substantially identical to the third embodiment, wherein here the second component 12 is provided with two ports (openings 18). In order to ensure a pressure-tight boundary between the two ports 18, the first component 10 is provided with a recess 24 (for example a saw-line) and the second component 12 is provided with a protrusion 22. When the first component 10 is brought into contact with the second component 12, the protrusion 22 is inserted into the recess 24. Subsequently the protrusion 22 is interlocked with the rough inner walls of the recess 24, and is thus joined to it in a pressure-tight manner, by heating and displacing the thermoplastic material.

The methods of the fifth and sixth embodiments shown schematically in FIGS. 5A to 6B are substantially identical to the method of the second embodiment, wherein here the second component 12 consists of two different materials 26, 28 and, similarly to the third and fourth embodiments, is provided with an opening 18. The first material 26 is a thermoplastic resin (polycarbonate, PC) and the second material 28 is aluminium. Since the second material 28 does not become deformable during heating even at the elevated temperature Tₚ and keeps thus its original shape during the entire joining process, the first component 10 stays fixed in its position in a vertical direction (direction of movement of the die 120, see FIGS. 5a and 6a). Joining the first component 10 with the second component 12 is exclusively effected by displacing the heated first material 26 (see FIGS. 5b and 6b). Here, the first material 26 can be a film applied onto the second material 28, as in the fifth embodiment (FIGS. 5a and 5b), or the second material 28 may be configured as insert around which the first material 26 is injection moulded (injection moulding), for example, like in the sixth embodiment (FIGS. 6a and 6b).

Compared to the method of the fifth embodiment, in the method of the seventh embodiment shown in FIGS. 7a and 7b the second component 12 additionally comprises a third material 30 arranged between the first material 26 and the second material 28. Such a material composite may for example be produced by conventional injection moulding methods. Alternatively, the third material 30 may also be first applied onto the second material 28 and, then, the first material 26 may be laminated onto it as film, for example. The third material 30 is electrically conducting and may for example be a commercially available electric circuit board. In order to allow electrical contacting of the third material 30 from the outside (for example for a connection to external current or voltage supplies or current or voltage meters etc), openings 32 are provided in the first material 26. Before the first component, which in this embodiment is provided with electric contacts, is inserted into the recess 14 of the second component 12, a conductive adhesive 34 is applied to the surface of the third material 30 of the second component 12 facing the first component (FIG. 7a). The first component 10 is then inserted into the recess 14 in such a manner that it is supported, via the adhesive layer 34, on the third material 30, with its electrical contacts facing down (that is in the direction of the third material). This type of chip orientation, that is with the electrical contacts facing down, is known in the art and is generally referred to as “flip-chip” orientation.

As in the fifth and sixth embodiment, joining the first component 10 to the second component 12 is exclusively effected by displacing the heated first material 26 (see FIG. 7b). When heating and displacing the first material 26, the die 120 initially only comes into contact with the first material 26, similarly to the second, fifth and sixth embodiments. After a sufficient amount of the first material 26 has been displaced, the die 120 contacts, with its flat central region, the upper surface of the first component 10 and presses it towards the conductive third material 30. By means of the pressure that is thus exerted onto the first component 10 a stable electric connection of the first component 10 with the third material 30 via the adhesive layer 34 is achieved. Additionally, the first component 10 is, like in the other embodiments, held fixed and in a pressure-tight manner by means of a combination of positive fit and clamping force applied by the first material 26, once the first material 26 is cooled below its softening temperature. Therefore, the method of the seventh embodiment is suited for a stable connection of electric or microelectric components, or, in general, microtechnological components which need electrical connections. The first component 10 may for example be a microvalve which can be opened and closed depending upon the voltage applied across the third material 30, and can thus correspondingly allow or prohibit a flow of fluid through the port 18.

In order to check the stability and the tightness behaviour of the joint produced by the methods of the invention, temperature-dependent test measurements were performed. Joints having a flat upper surface (see FIG. 9) and consisting of an un-patterned silicon chip 10 and a second component 12 made of different uniform thermoplastic materials (polymethyl methacrylate (PMMA), polycarbonate (PC), polyvinylene sulphide (PPS), polyether imide (PEI)) were produced as test objects by the method according to the third embodiment (FIG. 3).

The port 18 provided in the second component 12 was connected to a pressure regulator via a hose connection by means of which the pressure below the silicon chip 10 was controlled. The sealing behaviour of the joints was measured by applying a pressure of 2 bar to the lower side of the silicon chip 10 through the pressure regulator and by holding the joints into a glass container filled with water during the test measurements. The escape of air bubbles served as a first indication of a leakage of the joint under examination. The temperature dependence of the sealing behaviour of the joints was measured by slowly heating the water in the glass container by means of a heating plate. The water temperature was continuously determined by an electric temperature sensor. A more exact determination of the leakage rate was effected by means of a mass flow meter connected in series between the pressure regulator and the joint to be examined.

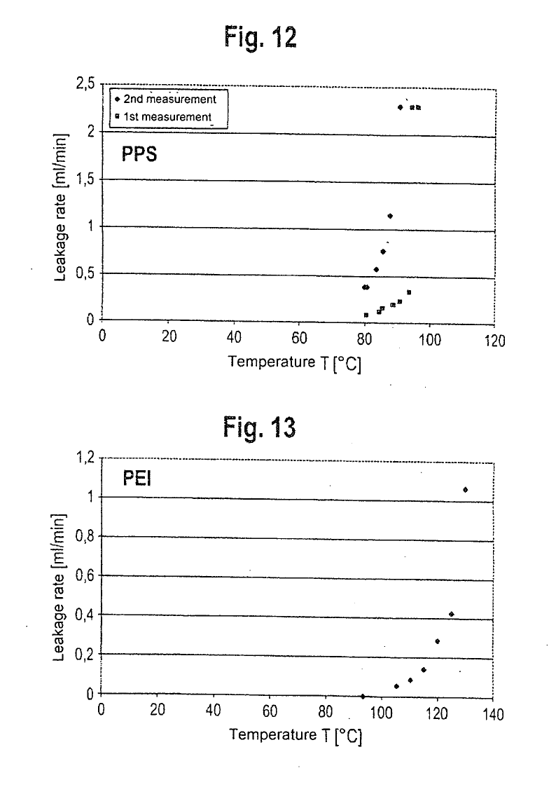

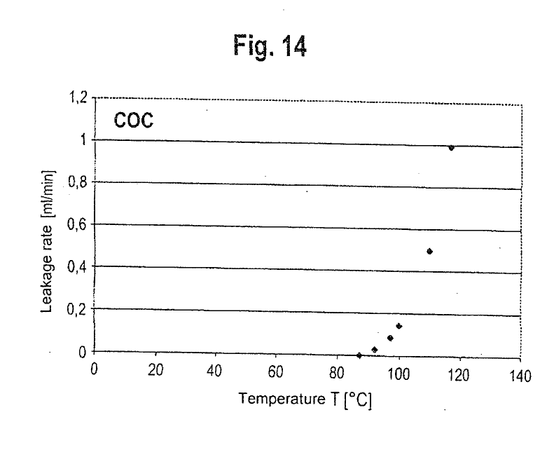

The results of these temperature-dependent measurements are shown in FIGS. 10 to 14 for joints having a second component 12 consisting of polymethyl methacrylate (PMMA, FIG. 10), polycarbonate (PC, FIG. 11), polyvinylene sulphide (PPS, FIG. 12), polyether imide (PEI, FIG. 13), cylcic-olefine copolymer (COC, FIG. 14). The measured data provides upper limit temperatures of 47° C. (PMMA), 38° C. (PC), 72° C. (PPS), 90° C. (PEI) and 85° C. (COC), below which the joints are pressure-tight at an applied pressure of 2 bar. Thus, the test measurements show that the method of the invention allows a stable joint of two components 10, 12, which is pressure-tight even at elevated pressures and temperatures.

The invention is not limited to the described embodiments but may be modified within the scope of the following claims.

1. Method of joining a first component to a second component, wherein the second component includes a thermoplastic material, and the method comprises the following steps:
bringing the first component into contact with the second component,
heating the thermoplastic material of the second component at least in the vicinity of the first component to a temperature above the softening temperature of the thermoplastic material but below the decomposition temperature of the thermoplastic material,
displacing the heated thermoplastic material so as to create an at least positive connection between the first component and the second component, and
cooling the thermoplastic material to a temperature below its softening temperature, wherein both the heating of the thermoplastic material and the displacement of the heated thermoplastic material is effected by a die, wherein the heating of the thermoplastic material is effected through heat conduction by bringing into direct contact the die heated to a temperature above the softening temperature of the thermoplastic material and either the first or the second component, or both components.

2. The method of claim 1, wherein the second component has a recess, and the first component is at least partially inserted into this recess in order to bring it into contact with the second component.

3. The method of claim 1, wherein the first component consists of a thermally conductive material and the heating of the thermoplastic material is effected through the first component.

4. The method of claim 3, wherein the thermoplastic material has a larger expansion coefficient than the material of the first component.

5. The method of claim 1, wherein the heating of the plastic material is effected through the second component.

6. (canceled)

7. The method of claim 3, wherein the die contacts the first component when heating the thermoplastic material and displacing the heated thermoplastic material.

8. The method of claim 5, wherein the die contacts the second component when heating the thermoplastic material and displacing the heated thermoplastic material.

9. The method according to claim 1, wherein the second component consists of at least two different materials.

10. The method of claim 9, wherein the at least two materials are thermoplastic materials having different softening temperatures.

11. The method of claim 10, wherein only the material having the lower softening temperature is heated to a temperature above its softening temperature.

12. The method of claim 9, wherein only one of the at least two materials is a thermoplastic material.

13. The method according to claim 1, wherein the second component includes an electrically conducting material which establishes an electric connection with the first component by joining the first component to the second component.

14. The method according to claim 1, wherein the first component consists of silicon or metal or glass or ceramics.

15. The method according to claim 1, wherein the first component is a microfluidic component, preferably a valve.
